(19) United States
(12) Patent Application Publication
(10) Pub. No.: US 2002/0023079 A1
(43) Pub. Date: Feb. 21, 2002

(54) Object management method and system

(75) Inventor: Hideki Matsunaga, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 09/923,440

(22) Filed: Aug. 8, 2001

(30) Foreign Application Priority Data
Aug. 16, 2000 (JP) 2000-246861

(51) Int. Cl. G06F 7/00

(52) U.S. Cl. 707/1; 707/104.1

(57) ABSTRACT

An object management method and system capable of performing access control for objects appropriately and reducing workload of administrators is provided. Retrieval conditions of objects are defined, and access rights are set for each of the retrieval conditions, and access control is performed on the basis of the set access rights if an object to be accessed matches any of the retrieval conditions.

### BACKGROUND OF THE INVENTION

1. Field of the Invention

The present invention relates to object management method and system. More specifically, the present invention relates to an object management method and system for controlling access to an object.

2. Description of the Prior Art

For file systems used in computers, conventionally, access rights are set in association with files or other objects. Access rights include READ, WRITE, DELETE, EXECUTE and other permissions for objects, and each access right is set for each object.

Access rights can individually be set in association with a user or a user group, which allows restriction of users accessible to each object.

In this way, with conventional object control, access rights can optionally be set on each object, and appropriate access control is provided.

However, while access rights can optionally be set on each object, there is a drawback that administrators are expected to set access rights on all objects, resulting in their workloads being enormously increased.

In addition, some access rights set on objects need to be dynamically altered as in the case where they are set on the basis of elapsed time period after the creation date of the objects. In such cases, administrators are expected to verify elapsed time after the creation date of the objects and change the settings of the access rights, also resulting in much expense in time and effort.

As described above, although conventional object control enables access rights to be optionally set on objects and provides appropriate access control, it enormously increases workloads of the administrators.

### SUMMARY OF THE INVENTION

The invention has been made in view of the above circumstances and provides an object management method and system wherein object access control is performed appropriately and workload of the administrators can be reduced.

In order to accomplish the foregoing, an aspect of the present invention provides an object management method for performing access control for a stored object which includes the steps of defining a retrieval condition for retrieving an object, setting an access right in association with the retrieval condition, and performing access control for an object matching the retrieval condition on the basis of the access right.

The method may further include the steps of performing a check, when a request for access to an object occurs, to see whether the object meets the retrieval condition, and controlling access to the access-requested object on the basis of the access right that has been set in association with the retrieval condition.

Alternatively, the method may further include the steps of setting an identifier for identifying each object in association with the retrieval condition, performing a check, when a request for access to an object occurs, to see whether the identifier of the object has been set in association with the retrieval condition, and controlling access to the access-requested object on the basis of the access right that has been set in association with the retrieval condition if a result of the check indicates that the identifier of the access-requested object has been set in association with the retrieval condition.

The association between the retrieval condition and the identifier may be changed according to need when addition, modification, or deletion of the object identified by the identifier is made.

Alternatively, the method may further include the step of performing access control, if the access-requested object matches multiple retrieval conditions, on the basis of OR of the matched retrieval conditions.

Alternatively, the method may further include the step of performing access control, if the access-requested object matches multiple retrieval conditions, on the basis of AND of the matched retrieval conditions.

The object may be stored with attribute data, and the retrieval condition may aim to retrieve the object on the basis of the attribute data.

Alternatively, the object may be stored with attribute data and a method for referring to an entity of the object, and the retrieval condition may aim to retrieve the object on the basis of the attribute data and the entity of the object referred to by the method.

The access right may be a specification about a user and an access type allowed to access the object.

According to another aspect of the present invention, an object management system, which performs access control for an object stored in a object storing part, includes an access control part for managing both a retrieval condition for retrieving an object and access right that has been set in association with the retrieval condition, thereby controlling access to the object, and a retrieval part for retrieving an object stored in the object storing part on the basis of the retrieval condition. The access control part performs access control for an object matching the retrieval condition on the basis of a retrieval result by the retrieval part.

The retrieval part may perform a check, when a request for access to an object occurs, to see whether the object matches the retrieval condition, and the access control part may control access to the access-requested object based on the access right that has been set in association with the retrieval condition if a retrieval result by the retrieval part indicates that the access requested object matches the retrieval condition.

Alternatively, the access control part may manage an identifier for identifying each object in association with the retrieval condition, and control, when a request for access to an object occurs and if the identifier of the object has been set in association with the retrieval condition, access to the access-requested object on the basis of the access right that has been set in association with the retrieval condition.

The retrieval part may retrieve an object stored in the object storing part when addition, modification, or deletion of the object is made, and the access control part may change the association between the retrieval condition and the identifier in accordance with a retrieval result by the retrieval part.

Alternatively, the access control part may perform access control, if an access-requested object matches multiple retrieval conditions, on the basis of OR of the matched retrieval conditions.

Alternatively, the access control part may perform access control, if an access-requested object matches multiple retrieval conditions, on the basis of AND of the matched retrieval conditions.

The object storing part may store an object with attribute data of the object, and the retrieval part may retrieve the object on the basis of the attribute data.

Alternatively, the object storing part may store an object with attribute data and a method for referring to an entity of the object, and the retrieval part may retrieve the object on the basis of the attribute data and the entity of the object referred to by the method.

The access control part may manage the access right as a specification of a user and an access type allowed to access the object.

### BRIEF DESCRIPTION OF THE DRAWINGS

Preferred embodiments of the present invention will be described in detail based on the followings, wherein:

FIG. 1 is a block diagram showing the configuration of an object management system 10;

FIG. 2 is a table showing a structure example of an access list;

FIG. 3 is a table showing a structure example of document data stored in an object storing unit 5;

FIG. 4 is a flowchart showing the operational flow of the object management system 10 when retrieval conditions are ORed:

FIG. 5 is a flowchart showing the operational flow of the object management system 10 when retrieval conditions are ANDed;

FIG. 6 is a table showing another structure example of document data;

FIG. 7 is a table showing another structure example of an access list;

FIG. 8 is a table showing a structure example of an access list for another embodiment of the object management method and system;

FIG. 9 is a flowchart showing the operational flow of the object management system 10 when retrieval conditions are ORed for another embodiment of the object management method and system;

FIG. 10 is a flowchart showing the operational flow of the object management system 10 when retrieval conditions are ANDed for another embodiment of the object management method and system;

FIG. 11 is a flowchart showing the operational flow of the object management system 10 when addition of an object is made;

FIG. 12 is a flowchart showing the operational flow of the object management system 10 when modification of an object is made; and

FIG. 13 is a flowchart showing the operational flow of the object management system 10 when deletion of an object is made.

### DESCRIPTION OF THE PREFERRED EMBODIMENTS

FIG. 1 is a block diagram showing the configuration of an object management system.

As shown in FIG. 1, an object management system 10 is configured with a request processing unit 1, an access control unit 2, a retrieval processing unit 3, an object processing unit 4, and an object storing unit 5.

The object management system 10 is an integral part of a computer system and performs object control.

The request processing unit 1 receives an access request to an object, such as a request to create the object, a request to write into the object, a request to delete the object, and a request to read out the object.

The access control unit 2 holds an access list and performs a check to see whether a user who made the access request has access to the object on the basis of the access list. The access list is a table describing retrieval conditions, user lists, access types and others, the details of which will be described later.

The retrieval processing unit 3 performs a retrieval to see whether the object that matches a retrieval condition received from the access control unit 2 exists in the object storing unit 5.

The object processing unit 4, following an access command received from the access control 2 and a retrieval command received from the retrieval processing unit 3, performs access to the object that has been stored in the object storing unit 5.

The object storing unit 5 stores the object with the attribute and other data.

The access list will now be described in detail.

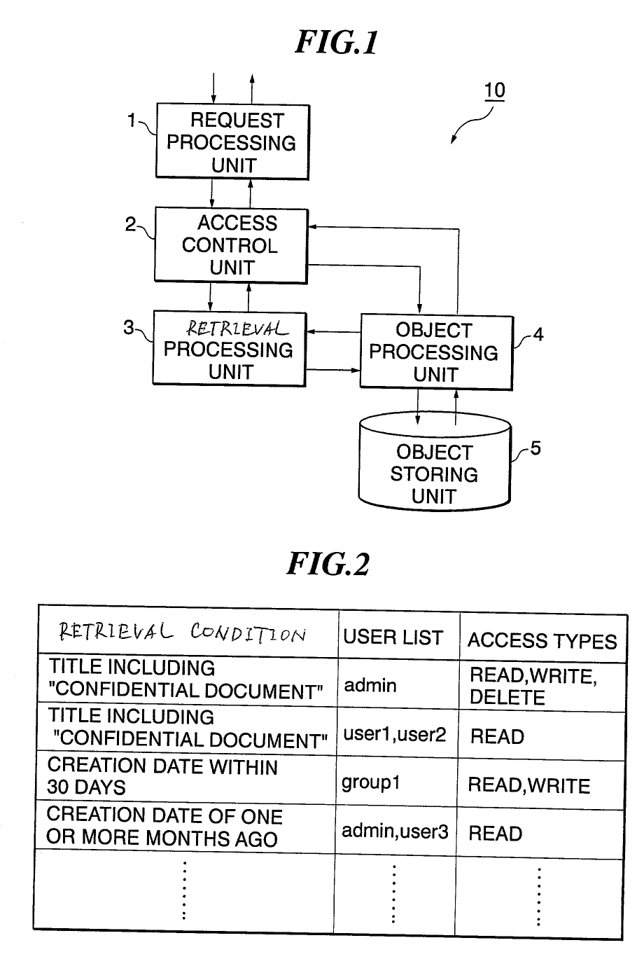

FIG. 2 is a table showing a structure example of the access list.

The access list describes retrieval conditions, user lists, and access types. The retrieval conditions indicates objects, and a user or a user group listed under User List is given access with an access type or access types listed under Access Type to the object that matches the retrieval conditions.

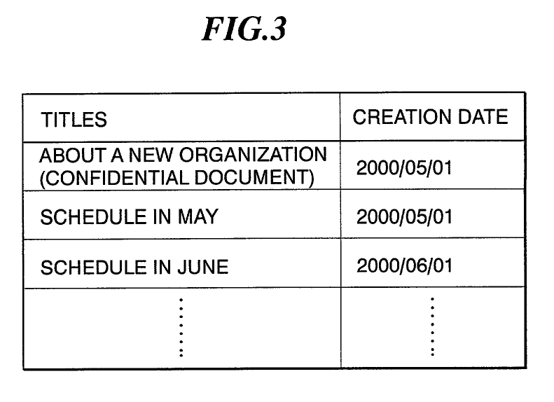

Suppose the object storing unit 5 has a document stored with the attributes as shown in FIG. 3. For a document titled “About a New Organization (Confidential Document)”, because it has a title including the letters “Confidential Document” and meets the retrieval condition of “Title including “Confidential Document””, user name [admin] authorized as an administrator is given access with READ, WRITE, and DELETE to the document, or is allowed to read out, write into, and delete the document. On the other hand, user names [user1] and [user2] are given access with READ, or are allowed only to read the document, and no other user is given access to the document.

From the retrieval condition “Creation date within 30 days”, each user belonging to a group name [group1] is given access to the document titled “Schedule in June” with READ and WRITE as of Jun. 20, 2000, but is not given access to the documents titled “About a New Organization (Confidential Document)” and “Schedule in May”.

In addition, from the retrieval condition of “Creation date of one or more months ago”, user names [admin] and [user3] is given access to the documents titled “About a New Organization (Confidential Document)” and “Schedule in May” with READ as of Jun. 20, 2000, but is not given access to the document titled “Schedule in June”.

Note that, although FIG. 3 shows the information (attributes) associated with the objects as a table, the information belongs to each object rather than a table. Nevertheless, the object storing 5 holding the information as a table presents no problem.

Some objects stored in the object storing unit 5 would match multiple retrieval conditions. For example, the document titled “About a New Organization (Confidential Document)” matches the retrieval conditions “Title including (Confidential Document)” and “Creation date of one or more months ago” (as of Jun. 20, 2000). In this case, the retrieval conditions are ORed or ANDed, and then access control is performed on the result. Whether the retrieval conditions are ORed or ANDed is predetermined.

If the retrieval conditions are ORed, user name [admin] is given access with READ, WRITE, and DELETE to the document titled “About a New Organization (Confidential Document)”, and only user names [user1] and [user2] are given access with READ until May 31, 2000, but, after Jun. 1, 2000, a user name [user3] is also given access with READ.

On the other hand, if the retrieval conditions are ANDed, only a user name [admin] is given access with READ, WRITE, and DELETE to the document titled “About a New Organization (Confidential Document)” regardless of the time and date.

Now, the operation of the object management system 10 when the retrieval conditions are ORed and ANDed will be described, respectively.

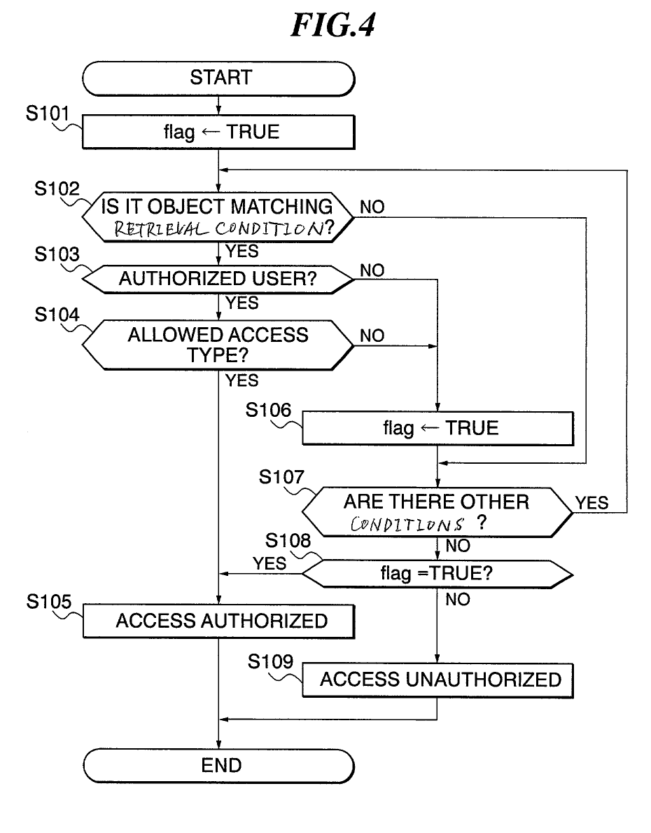

FIG. 4 is a flowchart showing the operational flow of the object management system 10 when the retrieval conditions are ORed.

The object management system 10 starts operation when the request processing unit 1 receives a request for access to an object. Then, the access control unit 2 receives the object to be accessed and the access type from the access request received by the request processing unit 1, and sets the flag to TRUE (Step 101).

The access control unit 2 passes the first retrieval condition in the access list to the retrieval processing unit 3 and causes it to perform a retrieval for the designated object. If the retrieval result indicates that the designated object matches the retrieval condition (YES at Step 102), the user who made a request for access is an authorized user (listed under User List of the access list)(YES at STEP 103), and if the access type is an allowed access type (listed under Access Types of the access list)(YES at Step 104), the access control unit 2 authorizes the access request (Step 105) and causes the object processing unit 4 to perform access to the designated object.

On the other hand, although the retrieval result by the retrieval processing unit 3 shows that the designated object matches the retrieval condition, if the user who made a request for access is not an authorized user (NO at Step 103) or if the access type is not an allowed access type for the retrieval condition (NO at Step 104), the access control unit 2 sets the flag to FALSE (Step 106). If there are any other retrieval conditions in the access list (YES at Step 107), the access control unit 2 repeats the same operation. If there are no other retrieval condition in the access list (NO at Step 107), because the flag has been set to FALSE, the access control unit 2 denies the access request (Step 109) and notifies it to the request processing unit 1.

If the access-requested object does not match any retrieval conditions in the access list (repetition of NO at Step 102 and YES at Step 107), it indicates unrestricted access to the object, and because the flag has been set to TRUE (YES at Step 108), the access control unit 2 authorizes the access request (Step 105) and causes the object processing unit 4 to perform access to the designated object.

In other words, when the retrieval conditions are ORed, if a user who made a request for access is an authorized user for any one of the matched retrieval conditions and allowed access types of the retrieval conditions have been designated as the access types, the user is given access, while, with a retrieval condition being matched, if the user who made a request for access is not an authorized user for the retrieval condition or the designated access type is not the allowed access type, the access is not authorized. If there are no retrieval conditions matching the access-requested object, it indicates unrestricted access to the object and the access is authorized.

FIG. 5 is a flowchart showing the operational flow of the object management system 10 when the retrieval conditions are ANDed.

The object management system 10 starts operation when the request processing unit 1 receives a request for access to an object. Then, the access control unit 2 receives the object to be accessed and the access type from the access request received by the request processing unit 1, and passes the first retrieval condition of the access list to the retrieval processing unit 3 and causes it to perform a retrieval for the designated object. When the retrieval result shows that the object matches the retrieval condition (YES at Step 201), if the user who made a request for access is not an authorized user for the retrieval condition (listed under User List of the access list)(NO at Step 202) or if the user is an authorized user (YES at Step 202) but the access type is not the allowed access type for the retrieval condition (listed under Access Types of the access list) (NO at Step 203), the access control unit 2 denies the access request (Step 204) and notifies it to the request processing unit 1.

On the other hand, when the retrieval result shows that the object matches the retrieval condition (YES at Step 201), if the user who made the request for access is an authorized user for the retrieval condition (YES at Step 202) and the access type is the allowed access type for the retrieval condition (YES at Step 203), as long as there are other retrieval conditions in the access list (YES at Step 205), the access control unit 2 repeats the same operation. If the user is an authorized user and the access type is an allowed access type for all the matched retrieval conditions (NO at Step 205), the access control unit 2 authorizes the access request (Step 206) and causes the object processing unit 4 to perform access to the designated object.

If the access-requested object has no matching retrieval conditions in the access list (repetition of NO at Step 201 and YES at Step 205), the access control unit 2 determines that access to the object is unrestricted and authorizes the access request (Step 206), and causes the object processing unit 4 to perform access to the designated object.

In other words, when the retrieval conditions are ORed, if the user who made a request for access is an authorized user for all the matched retrieval conditions and allowed access types are designated as the access types, the access is authorized, while, in spite of the retrieval conditions being matched, if the user who made a request for access is not an authorized user or the designated access type is not an allowed access type for any one of the retrieval conditions, the access is denied. If there are no retrieval conditions matching the access-requested object, it is determined that access to the object is unrestricted and the access is authorized.

The structure of the access list held by the access control unit 2 and the structure of the information (attribute and other data) associated with objects stored in the object storing unit 5 are not limited to the structure mentioned above.

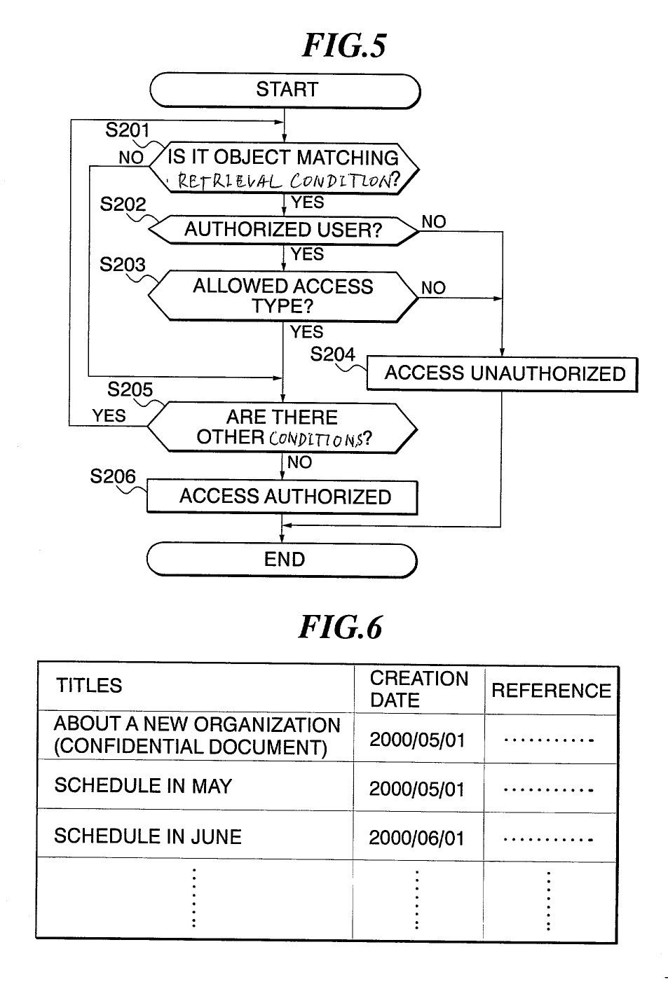

For example, as shown in FIG. 6, the information associated with the objects stored in the object storing unit 5 can be structured with not only the attributes but with the references (paths) to the entities of the objects. This allows a full-text retrieval when an object is a text file, and allows a retrieval condition such as “Main body including (ABC)” to be contained as a retrieval condition described in the access list.

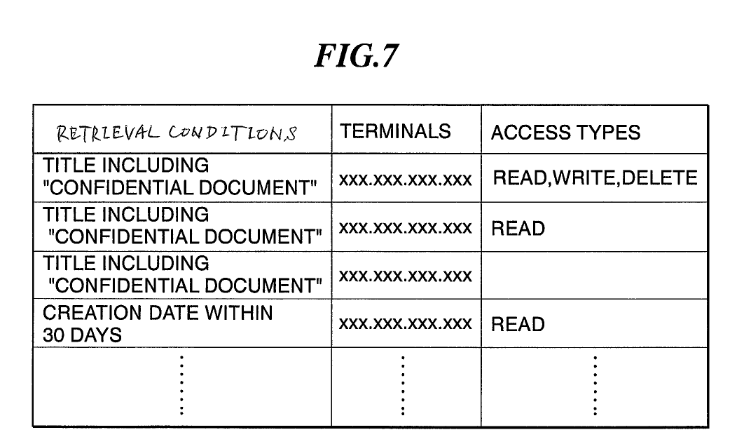

Furthermore, as shown in FIG. 7, the access list held by the access control unit 2 can also be structured with retrieval conditions, terminal lists, and access types. If a terminal list is included as an element of the access list instead of a user list, it becomes possible to set an access right on every location of terminals (e.g., on the room-to-room basis). Without limiting to replacement of a user list with a terminal list as an element of the access list, it is also possible by adding terminal list to user list to impose limitations on the authorized users to access only from the designated terminals.

The structure of the access list held by the access control unit 2 or the structure of the information (attributes and other data) associated with the objects stored in the object storing unit 5 as shown here are only an example, and many other elements can be used to limit access.

Next, another embodiment of an object management method and system relating to this invention will be described.

Since the embodiment to be described here differs from the embodiment mentioned above only in the structure of the access list and operation, and the configuration of an object management system is the same, it will be described by referring to the object management system 10 shown in FIG. 1.

Here, the retrieval processing unit 3 does not perform a retrieval for an object when the access request is made to the request processing unit 1, but it performs a retrieval for the object every time addition, modification, or deletion of the object is made, and the access control unit 2 stores the retrieval result in the access list.

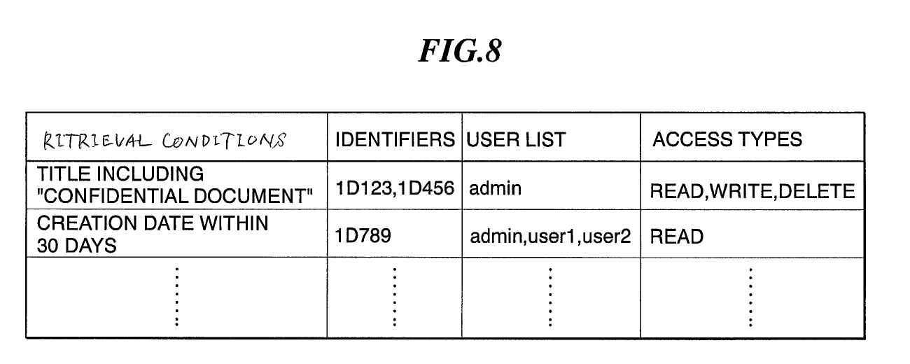

The access list in this case, as shown in FIG. 8, is made up of retrieval conditions, and the identifiers, user list, and access types of objects that match the retrieval conditions. The identifiers of the objects are associated with objects stored in the object storing unit 5 in a one-to-one relationship, and access to objects can be performed on the basis of the identifiers.

In this structure, an access right is determined by an identifier. When addition, modification, or deletion of an object is made, the identifier of an object described in the access list is changed, which is notified to the administrator.

First, the operations for determining an access right will be described.

An access right, as in the case described above, is decided based on whether the retrieval conditions are ORed or ANDed.

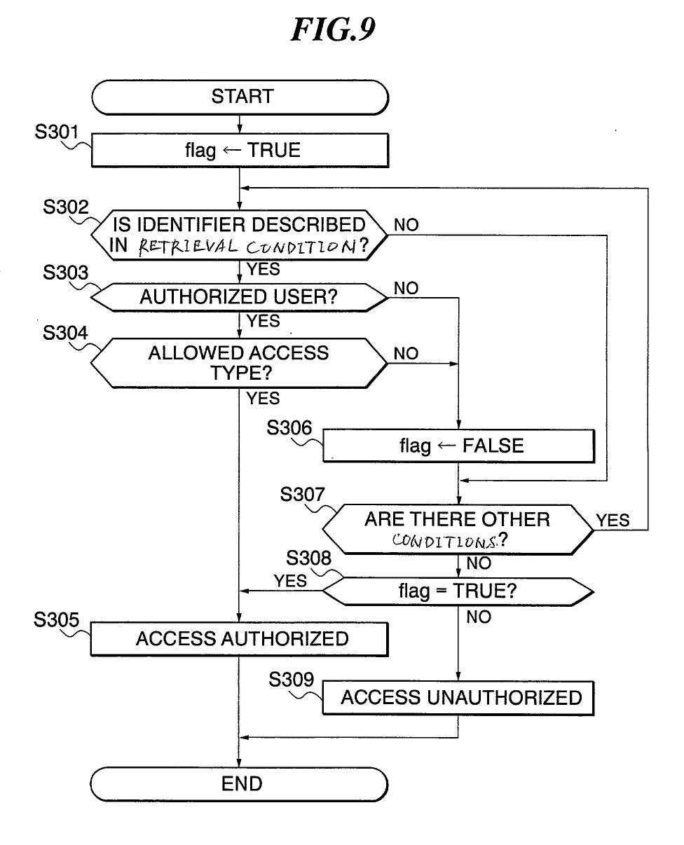

FIG. 9 is a flowchart showing the flow of operation of the object management system 10 when the retrieval conditions are ORed.

The object management system 10 starts operation when the request processing unit 1 receives a request for access to an object. Then it receives the designated object and the access type from the access request received by the request processing unit 1, and sets the flag to TRUE (Step 301).

Then, the access control unit 2 performs a check to see whether the identifier of an object designated in the first retrieval condition of the access list has been described. When the check result shows that the identifier of the object has been described in association with the retrieval condition (YES at Step 302), if the user who made a request for access is an authorized user for the retrieval condition (YES at Step 303) and the access type is an allowed access type for the retrieval condition (YES in Step 304), the access control unit 2 authorizes the access request (Step 305) and causes the object processing unit 4 to perform access to the designated object.

On the other hand, the access control unit 2, in spite of the result by a check of description of the identifier showing that the identifier of the designated object has been described in association with the retrieval condition, if the user who made a request for access is not an authorized user for the retrieval condition (NO at Step 303) or if the access type is not an allowed access type for the retrieval condition (NO at Step 304), set the flag to FALSE (Step 306). Then, if there are other retrieval conditions in the access list (YES at Step 307), the access control unit 2 repeats the same processing such as performing a check of the description of the identifier in the retrieval condition. If there are no other retrieval condition (NO at Step 307), because the flag has been set to FALSE (NO at Step 308), the access control unit 2 denies the access request (Step 309) and notifies it to the request processing unit 1.

If the identifier of the access-requested object has not been described in association with any one of the retrieval conditions (repetition of NO at Step 302 and YES at Step 307), the access control unit 2 determines that access to the object is unrestricted, and because the flag has been set to TRUE (YES at Step 308), authorizes the access request (Step 305) and causes the object processing unit 4 to perform access to the designated object.

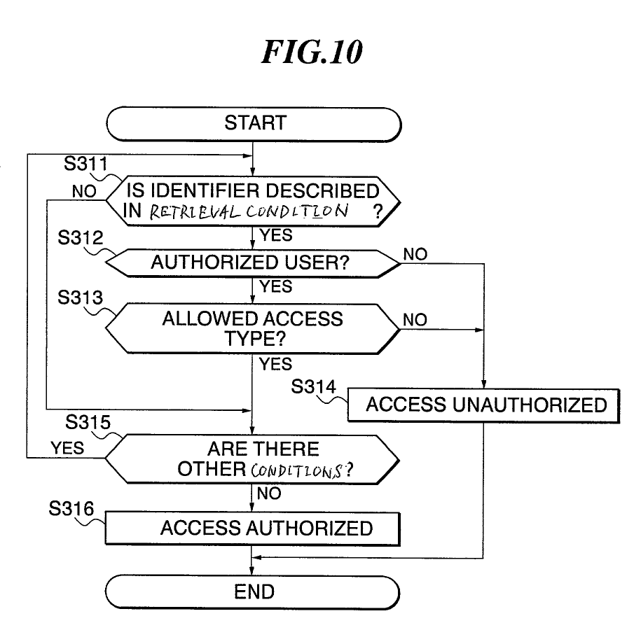

FIG. 10 is a flowchart showing the flow of operation of the object management system 10 when the retrieval conditions are ANDed.

The object management system 10 starts operation when the request processing unit 1 receives a request for access to an object. Then, the access control unit 2 receives the designated object and the access type from the access request received by the request processing unit 1, and performs a check to see whether the identifier of the designated object has been described in the first retrieval condition of the access list. When the check result shows that the identifier of the object has been described in association with the retrieval condition (YES at Step 311), if the user who made a request for access is not an authorized user for the retrieval condition (NO at Step 312), or if the user is an authorized user (YES at Step 312) but the access type is not an allowed access type for the retrieval condition (NO at Step 313), the access control unit 2 denies the access request (Step 314) and notifies it to the request processing unit 1.

On the other hand, when the check result shows that the identifier of the object has been described in association with the retrieval condition (YES at Step 311), if the user who made a request for access is an authorized user in the retrieval condition (YES at Step 312) and the access type is an allowed access type in the retrieval condition (YES at Step 313), the access control unit 2 repeats the same processing (YES at Step 315) as long as there are other retrieval conditions in the access list. If the user is an authorized user and the access type is an allowed access type for all the retrieval conditions with identifiers described (NO at Step 315), the access control unit 2 authorizes the access request (Step 316) and causes the object processing unit 4 to perform access to the designated object.

If the access-requested object has not been described in association with any one of the retrieval conditions in the access list (repetition of NO at Step 311 and YES at Step 315), the access control unit 2 determines that access to the object is unrestricted, authorizes the access request (Step 316), and causes the object processing unit 4 to perform access to the designated object.

Next, the operation of the object management system 10 when addition, modification, or deletion of an object is made will be described.

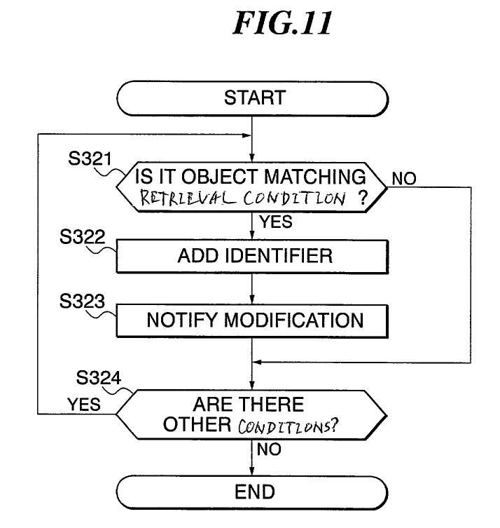

FIG. 11 is a flowchart showing the operational flow of the object management system 10 when an objected is added.

When the request processing unit 1 received a request for addition of an object, the access control unit 2 causes the object processing unit 4 to add the object to the object storing unit 5, the access control unit 2 passes the first retrieval condition of the access list to the retrieval processing unit 3 and causes it to perform a check to see whether the added object matches the retrieval condition (Step 321).

If the check result shows that the added object matches the retrieval condition (YES at Step 322), the access control unit 2 adds the identifier of the added object in association with the retrieval condition (Step 323), and notifies it to the administrator. Notification to the administrator is made as an error message or verification message, as well as by electronic male or by keeping logs.

If there are any other retrieval conditions in the access list (YES at Step 324), the access control unit 2 passes the retrieval condition to the retrieval processing unit 3, repeats the same processing, and after finishing the same processing for all the retrieval conditions of the access list (NO at Step 324), ends the processing.

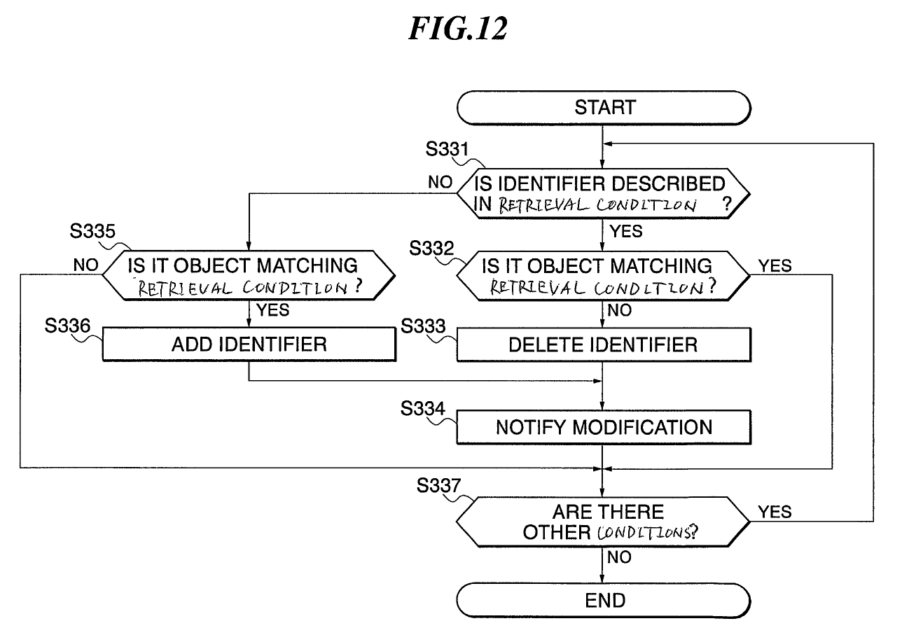

FIG. 12 is a flowchart showing the operational flow of the object management system 10 when modification of an object is made.

When the request processing unit 1 received a request for modification of an object, the access control unit 2 causes the object processing unit 4 to modify the object stored in the object storing unit 5, and performs a check to see whether the identifier of the object has been described in the first retrieval condition of the access list (Step 331). As a matter of course, only a user authorized by access control can perform modification of an object.

If the check result shows that the identifier of the object has been described (YES at Step 331), the access control unit 2 passes the retrieval condition to the retrieval processing unit 3 and causes it to perform a check to see whether the object matches the retrieval condition (Step 332). As a result of this check, if the object matches the retrieval condition (YES at Step 332), the access control unit 2 determines that the modification of the object has no effect on the retrieval condition and does nothing. If the check result shows the object does not match the retrieval condition (NO at Step 332), the access control unit 2 deletes the identifier of the object associated with the retrieval condition (Step 333), and notifies it to the administrator (Step 334). Notification to the administrator is made as an error message or verification message, as well as by electronic male or by keeping logs.

On the other hand, even if the check result at Step 331 shows that the identifier of the object has not been described (NO at Step 331), the access control unit 2 passes the retrieval condition to the retrieval processing unit 3 and causes it to perform a check to see whether the object matches the retrieval condition (Step 335). If the check result shows that the object matches the retrieval condition (YES at Step 335), the access control unit 2 adds a new identifier of the object in association with the retrieval condition (Step 336), and notifies it to the administrator (Step 334). If the check result shows that the object does not match the retrieval condition (NO at Step 335), the access control unit 2 determines that the modification of the object has no effect on the retrieval condition and does nothing.

The access control unit 2 repeats these processes for all the retrieval conditions described in the access list (YES at Step 337), and after finishing the same processing for all the retrieval conditions (NO at Step 337), ends the processing for modification of the object.

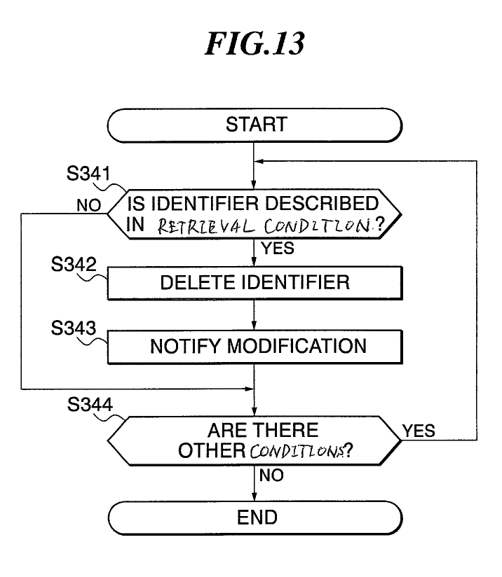

FIG. 13 is a flowchart showing the operational flow of the object management system 10 when deletion of an object is made.

When the request processing unit 1 receives a request for modification of an object, the access control unit 2 causes the object processing unit 4 to delete the object from the object storing unit 5, and performs a check to see whether the identifier of the deleted object has been described in the first retrieval condition of the access list (Step 341). As a matter of course, only a user authorized by access control can perform deletion of an object.

If the check result shows that the identifier of the deleted object has been described in association with the retrieval condition (YES at Step 341), the access control unit 2 deletes the identifier of the object from the retrieval condition (Step 342), and notifies it to the administrator (Step 343). Notification to the administrator is made as an error message or verification message, as well as by electronic male or by keeping logs.

On the other hand, if the identifier of the deleted object has not been described in association with the retrieval condition (NO at Step 341), nothing is done for the retrieval condition.

If there are other retrieval conditions (YES at Step 344), the same processing is repeated for the existing retrieval conditions, and after the same processing is done for all the retrieval conditions of the access list (NO at Step 344), the processing is ended.

Although, in this processing for addition, modification, and deletion of an object, notification to the administrator is made both when the identifier associated with an object is added to the retrieval condition and when it is deleted from the retrieval condition, it is also possible to cause notification to be made only when the identifier is deleted. It is further possible to cause notification to the administrator to be made in different ways such as in messages or by electronic mail when identifiers are deleted and by keeping logs when identifiers are added.

As described above, the present invention, because it is configured in a manner that retrieval conditions of objects are defined, access rights for each retrieval condition are set, and access control is performed on the basis of the set access rights if an object to be accessed matches the retrieval condition, makes setting of access rights for each object easier, as well as enables access rights to be dynamically changed, contributing to reduced workload of administrators and avoided setting errors of access rights.

In addition, controlling the identifier of an object matching a condition in association with the retrieval condition makes it easier, when addition, modification, or deletion of an object is made, to notify the administrator that the association between the object and the retrieval condition has been changed.

The entire disclosure of Japanese Patent Application No. 2000-24861 filed on Aug. 16, 2000 including specification, claims, drawings and abstract is incorporated herein by reference in its entirety.

What is claimed is:

1. An object management method for performing access control for a stored object, the method comprising the steps of:
defining a retrieval condition for retrieving an object;
setting an access right in association with the retrieval condition; and
performing access control for an object matching the retrieval condition on the basis of the access right.

2. The object management method according to claim 1, further comprising the steps of:
performing a check, when a request for access to an object occurs, to see whether the object meets the retrieval condition; and
controlling access to the access-requested object on the basis of the access right that has been set in association with the retrieval condition.

3. The object management method according to claim 1, further comprising the steps of:
setting an identifier for identifying each object in association with the retrieval condition;
performing a check, when a request for access to an object occurs, to see whether the identifier of the object has been set in association with the retrieval condition; and
controlling access to the access-requested object on the basis of the access right that has been set in association with the retrieval condition if a result of the check indicates that the identifier of the access-requested object has been set in association with the retrieval condition.

4. The object management method according to claim 3, wherein the association between the retrieval condition and the identifier is changed according to need when addition, modification, or deletion of the object identified by the identifier is made.

5. The object management method according to claim 2, further comprising the step of:
performing access control, if the access-requested object matches a plurality of retrieval conditions, on the basis of OR of the matched retrieval conditions.

6. The object management method according to claim 2, further comprising the step of:
performing access control, if the access-requested object matches a plurality of retrieval conditions, on the basis of AND of the matched retrieval conditions.

7. The object management method according to claim 1, wherein the object is stored with attribute data, and the retrieval condition aims to retrieve the object on the basis of the attribute data.

8. The object management method according to claim 1, wherein the object is stored with attribute data and a method for referring to an entity of the object, and the retrieval condition aims to retrieve the object on the basis of the attribute data and the entity of the object referred to by the method.

9. The object management method according to claim 1, wherein the access right is a specification about a user and an access type allowed to access the object.

10. An object management system performing access control for an object stored in object storing means, the system comprising:
access control means for managing both a retrieval condition for retrieving an object and access right that has been set in association with the retrieval condition, thereby controlling access to the object; and
retrieval means for retrieving an object stored in the object storing means on the basis of the retrieval condition,
wherein the access control means performs access control for an object matching the retrieval condition on the basis of a retrieval result by the retrieval means.

11. The object management system according to claim 10, wherein the retrieval means performs a check, when a request for access to an object occurs, to see whether the object matches the retrieval condition, and the access control means controls access to the access-requested object based on the access right that has been set in association with the retrieval condition if a retrieval result by the retrieval means indicates that the access-requested object matches the retrieval condition.

12. The object management system according to claim 10, wherein the access control means manages an identifier for identifying each object in association with the retrieval condition, and controls, when a request for access to an object occurs and if the identifier of the object has been set in association with the retrieval condition, access to the access-requested object on the basis of the access right that has been set in association with the retrieval condition.

13. The object management system according to claim 12, wherein the retrieval means retrieves an object stored in the object storing means when addition, modification, or deletion of the object is made, and the access control means changes the association between the retrieval condition and the identifier in accordance with a retrieval result by the retrieval means.

14. The object management system according to claim 10, wherein the access control means performs access control, if an access-requested object matches a plurality of retrieval conditions, on the basis of OR of the matched retrieval conditions.

15. The object management system according to claim 10, wherein the access control means performs access control, if an access-requested object matches a plurality of retrieval conditions, on the basis of AND of the matched retrieval conditions.

16. The object management system according to claim 10, wherein the object storing means stores an object with attribute data of the object, and the retrieval means retrieves the object on the basis of the attribute data.

17. The object management system according to claim 10, wherein the object storing means stores an object with attribute data and a method for referring to an entity of the object, and the retrieval means retrieves the object on the basis of the attribute data and the entity of the object referred to by the method.

18. The object management system according to claim 10, wherein the access control means manages the access right as a specification of a user and an access type allowed to access the object.
